(19) United States
(12) Patent Application Publication
(10) Pub. No.: US 2010/0134632 A1
(43) Pub. Date: Jun. 3, 2010

(54) APPARATUS FOR TRACKING AN OBJECT USING A MOVING CAMERA AND METHOD THEREOF

(75) Inventors: Jongho WON, Daejeon-city (KR); Eunjin KOH, Incheon (KR); Changseok BAE, Daejeon-city (KR); Jintae KIM, Daejeon-city (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, Daejeon-city (KR)

(21) Appl. No.: 12/629,331

(22) Filed: Dec. 2, 2009

(30) Foreign Application Priority Data
Dec. 3, 2008 (KR) 10-2008-0121648
Oct. 22, 2009 (KR) 10-2009-0100761

(51) Int. Cl. G06K 9/00; H04N 11/00

(52) U.S. Cl. 348/169; 382/103; 348/E11.001

(57) ABSTRACT

Provided is an apparatus for tracking an object, including: a dynamic area extracting unit that extracts an object to be tracked from an image frame collected through an image collecting apparatus; an object modeling unit that models the object to be tracked extracted through the dynamic area extracting unit to calculate the color distribution of the object to be tracked; and an object tracking unit that calculates the color distribution of a next image frame collected through the image collecting apparatus, after calculating the color distribution of the object to be tracked, and calculates a posterior probability that each pixel belongs to the object to be tracked in the next image frame based on the calculated color distribution of the next image frame and the color distribution of the object to be tracked to track the object to be tracked.

### RELATED APPLICATIONS

The present application claims priority to Korean Patent Application Serial Number 10-2008-0121648, filed on Dec. 3, 2008 and Korean Patent Application Serial Number 10-2009-100761, filed on Oct. 22, 2009, the entirety of which are hereby incorporated by reference.

### BACKGROUND OF THE INVENTION

1. Field of the Invention

The present invention relates to an apparatus for tracking an object using a moving camera and a method thereof, and more particularly, to an apparatus that dynamically models an object to be tracked for a short time and tracks the object by continusouly moving a camera in order to track the modeled object, and a method thereof.

2. Description of the Related Art

A general method for tracking a moving object mostly uses a still camera or two cameras, wherein one is used as reference and the other is used as pan/tilt/zoom (PTZ).

However, in the case of the method for tracking the moving object using a still camera, it has a disadvantage in that further tracking cannot be performed, if the moving object gets out of the range of a screen, and a digital zoom rather than an optical zoom should be used in order to see the object more accurately. However, this does not allow the object to be seen more accurately but merely allows only the information of the original image to be more largely magnified so as to be seen.

In the case of the method for tranking the moving object using two cameras, a calibration step of two cameras is required and a gap occurs in the movable range of the PTZ when they are used over a long time, causing an inconvenience that the calibration should be performed again.

Therefore, several methods have been proposed in order to solve the disadvantages of the method for tracking the object in the related art, wherein methods such as MeanShift, CamShift, and ABCShift have been evaluated as the most successful object tracking methods. However, in the cases of the MeanShift and the CamShift, an original Shift method has been proposed for a camera that has little motion so that if the camera is continuously moved, having a disadvantage that tracking reliability is rapidly dropped. In the case of the ABCShift, although modeling on the background is continuously performed while tracking the object, the modeling of the object to be actually tracked uses a sheet of an initial frame and assumes the entirety of an area input from a user as the object to be tracked, having a limitation in more accurately modeling the object.

### SUMMARY OF THE INVENTION

The present invention proposes to solve the above problem. It is an object of the present invention to provide an apparatus that dynamically extracts an object to be tracked from an image collected through a camera and then calculates the probability that it is the object to be tracked through a statistical method using the color distribution of the object to be tracked obtained from modeling the extracted object to be tracked and the color distribution of the background obtained by continuously performing modeling on the background, thereby making it possible to perform object tracking with high reliability even when using a moving camera, and a method thereof.

In order to achieve the above object, there is provided an apparatus for tracking an object, including: a dynamic area extracting unit that extracts an object to be tracked from an image frame collected through an image collecting apparatus; an object modeling unit that models the object to be tracked extracted through the dynamic area extracting unit to calculate the color distribution of the object to be tracked; and an object tracking unit that calculates the color distribution of a next image frame collected through the image collecting apparatus, after calculating the color distribution of the object to be tracked, and calculates a posterior probability that each pixel belongs to the object to be tracked in the next image frame based on the calculated color distribution of the next image frame and the color distribution of the object to be tracked to track the object to be tracked.

In particular, the dynamic area extracting unit extracts the object to be tracked for the image frame collected through the still image collecting apparatus.

Moreover, the dynamic area extracting unit includes: a color space converting unit that converts the color space of the input image frame into a target color space to which weights for each image channel are given; and a data processing unit that processes image data of which color space is converted through the color space converting unit to separate the object to be tracked from background.

Furthermore, the apparatus for tracking the object further includes a post-processing unit that removes noise from the resultant image of the data processing unit to highlight the object to be tracked.

In addition, the object tracking unit includes a tracking unit that determines the size and center of the object to be tracked using the calculated posterior probabilities.

Moreover, the object tracking unit includes a driving control unit that controls the vision direction of the image collecting apparatus so that the center of the object to be tracked determined through the tracking unit is positioned at the center of the next image frame collected through the image collecting apparatus.

Furthermore, the object modeling unit uses a histogram to model the extracted object to be tracked and uses the different number of bins to be used in the histogram for each channel.

In addition, the dynamic area extracting unit extracts the object to be tracked from a plurality of image frames collected through the still image collecting apparatus, and the object modeling unit performs modeling on the objects to be tracked extracted through the plurality of image frames to calculate the color distribution of the object to be tracked.

Moreover, the object modeling unit models the object to be tracked until the modeling probability of the object to be tracked reaches convergence.

Furthermore, the object modeling unit performs modeling on the objects to be tracked extracted through the plurality of image frames and then calculates the color distribution of the object to be tracked using an average value of each modeling probability.

Meanwhile, there is provided a method for tracking an object, including: extracting an object to be tracked from an image frame collected through an image collecting apparatus; calculating the color distribution of the object to be tracked by modeling the extracted object to be tracked; calculating the color distribution of the object to be tracked and then calculating the color distribution of a next image frame collected through the image collecting apparatus; and calculating a posterior probability that each pixel belongs to the object to be tracked in the next image frame based on the calculated color distribution of the next image frame and the color distribution of the object to be tracked to track the object to be tracked.

In particular, the extracting the object to be tracked from the image frame collected through the image collecting apparatus comprises extracting the object to be tracked for the image frame collected through the still image collecting apparatus.

Moreover, the calculating the posterior probability that each pixel belongs to the object to be tracked in the next image frame based on the calculated color distribution of the next image frame and the color distribution of the object to be tracked to track the object to be tracked includes determining the size and center of the object to be tracked using the calculated posterior probability.

Furthermore, the calculating the posterior probability that each pixel belongs to the object to be tracked in the next image frame based on the calculated color distribution of the next image frame and the color distribution of the object to be tracked to track the object to be tracked includes controlling the vision direction of the image collecting apparatus so that the center of the object to be tracked is positioned at the center of the next image frame collected through the image collecting apparatus.

In addition, the calculating the color distribution of the object to be tracked by modeling the extracted object to be tracked comprises using a histogram to model the extracted object to be tracked and using the different number of bins to be used in the histogram for each channel.

Moreover, the calculating the color distribution of the object to be tracked by modeling the extracted object to be tracked comprises performing modeling on the objects to be tracked extracted through the plurality of image frames to calculate the color distribution of the object to be tracked.

Furthermore, the performing modeling on the objects to be tracked extracted through the plurality of image frames comprises modeling the object to be tracked until the modeling probability of the extracted object to be tracked reaches convergence.

In addition, the performing modeling on the objects to be tracked extracted through the plurality of image frames comprises performing modeling on the objects to be tracked extracted through the plurality of image frames and then calculating the color distribution of the object to be tracked using an average value of each modeling probability.

Moreover, the calculating the posterior probability that each pixel belongs to the object to be tracked in the next image frame based on the calculated color distribution of the next image frame and the color distribution of the object to be tracked to track the object to be tracked includes: determining whether the object to be tracked exist in the next image frame using the calculated posterior probabilities; when the object to be tracked does not exist in the next image frame, zoom-out controlling the image collecting apparatus at a predetermined ratio; and determining whether the object to be tracked exist in the next image frame using the image zoom out collecting apparatus at a predetermined ratio.

According to the present invention, the following acting effects can be obtained:

The method for tracking the object using the moving camera according to the present invention, which is a method of capable of effectively tracking an object to be tracked by controlling the division direction of the camera according to the motion of the object to be tracked, makes a tough object tracking possible even in an environment where the object and background move together compared to a method for tracking an object using a still camera in the related art. This is the reason that modeling is performed on only the object to be tracked in the related art. However, modeling is performed for each frame by also considering the neighboring environment thereof in the present invention.

Therefore, adaptive object tracking can be performed even in the environment where the neighboring background is continuously changed as the camera is moved together with the object.

Moreover, the tracking based on the probability using the color distribution of the object to be tracked rather than the template matching method is performed, making it possible to continuously track the object to be tracked, even though the size thereof is changed.

### BRIEF DESCRIPTION OF THE DRAWINGS

FIG. 1 is a diagram explaining an apparatus for tracking an object in a moving environment according to an embodiment of the present invention;

FIGS. 2A, 2B and 3 are exemplified diagrams explaining processes of extracting an object to be tracked from the dynamic area extracting unit of FIG. 1 to an input frame image;

FIG. 4 is an exemplified diagram explaining a process of calculating a color distribution by modeling the object to be tracked form the object modeling unit of FIG. 1; and

FIG. 5 is an exemplified diagram explaining a method for tracking an object using a moving environment according to the embodiment of the present invention.

FIGS. 6 and 7 are flow charts explaining a method for effectively tracking an object using a moving camera according to the embodiment of the present invention.

### DETAILED DESCRIPTION OF THE PREFERRED EMBODIMENTS

Hereinafter, the preferred embodiments of the present invention will be described in detail with reference to the accompanying drawings. Herein, the repeated explanation and the detailed description on the well-known function and constitution which may make the gist of the present invention obscure will be omitted. The embodiments of the present invention will be provided in order to more perfectly explain the present invention to those skilled in the art. Therefore, the shape, size or the like of elements in the drawings may be exaggerated for more definite explanation. Like reference numerals refer to like elements throughout.

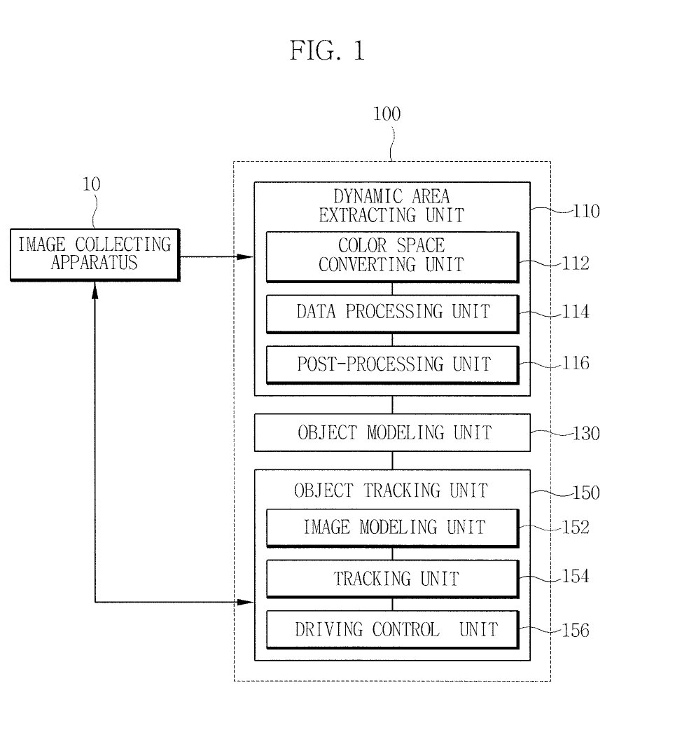

FIG. 1 is a diagram explaining an apparatus for tracking an object using a moving camera according to an embodiment of the present invention.

Referring to FIG. 1, the object tracking apparatus 100 according to the present invention includes a dynamic area extracting unit 110 that extracts an object to be tracked from an image frame collected through an image collecting apparatus 10, an object modeling unit 130 that calculates a color distribution of the object to be tracked by modeling the object to be tracked extracted through the dynamic area extracting unit 110, and an object tracking unit 150 that, after calculating the color distribution of the object to be tracked, calculates a color distribution of a next image frame collected through the image collecting apparatus 10, and calculates a posterior probability that each pixel is to be belonged to the object to be tracked in the next image frame based on the color distribution of the calculated next image frame and the color distribution of the object to be tracked to track the object to be tracked.

Hereinafter, each constituent that constitutes the object tracking apparatus 100 will be described in more detail.

The dynamic area extracting unit 110 extracts an object to be tracked from an image frame collected through an image collecting apparatus (for example, a camera). The dynamic area extracting unit 110 extracts the object to be tracked since the object to be tracked is selected from a user or the object to be tracked is shown on a screen, for the image frame collected through a still image collecting apparatus 10. Although the extracting process of the object to be tracked may be performed even during the moving of the image collecting apparatus 10, the reliability of the tracking may be dropped, such that it is preferable to extract the object to be tracked from the image frame collected while the image collecting apparatus 10 is still. Also, although any one may be the color space of the input image frame, color space where each channel has different meanings such as YUV or HSV rather than color space where each channel has the same meaning such as RGB is recommended. Such characteristics may be usefully used when each channel has different weight. Herein, the ‘object to be tracked’ means a moving object that the object tracking apparatus 100 according to the present invention should track.

Hereinafter, it will be regarded that the dynamic area extracting unit 110 extracts the object to be tracked by receiving the object to be tracked selected from a user. However, the time point when the dynamic area extracting unit 110 starts to extract the object to be tracked is not limited to the method but the object to be tracked (dynamic area) can be extracted from the image frame by diverse trigger signals.

The dynamic area extracting unit 110 includes a color space converting unit 112, a data processing unit 114, and a post-processing unit 116.

The color space converting unit 112 converts the color space of the image frame input from the image collecting apparatus 10 into object color space given with weight for each image channel. The color space converting unit 112 converts the color space of the input image into a target color space that can be easily processed in order to improve that each channel is processed by giving the same weight, assuming that it has the same distribution, when a Gaussian mixture model (GMM) is generally used. The converted target color space is not determined as a specific color space but it may use various color spaces conforming to each target. For example, the converted target color space may use a color space such as HSV that color of a pixel is used as one channel and YUV that a color space or brightness is used as one channel, etc. In YUV, Y means brightness of each pixel and when targeting a tracking system of an object more sensitive to brightness, the target may be achieved by giving higher weight to the Y channel, wherein this method may be applied to not only a high resolution image but also a method for extracting a general object. In the present invention, the channel means attribute elements such as colors constituting an image or brightness, etc. As the weights for each image channel as above are differed, it can bring the characteristics of each color space, such as emphasizing the change in colors or change in brightness, etc., and can obtain more accurate results.

The data processing unit 114 serves to separate the object to be tracked from the background by effectively processing the data of the input image converted through the color space converting unit 112. First, in allocating memory for information to be maintained throughout the tracking of the object, each pixel is allocated with GMM by the number multiplying the number of channels with the number of regular distribution to be maintained. Therefore, assuming that C is the channel of the input image, W is the width of the input image, H is the height of the input image, K is the number of Gaussian model to be maintained, and N is the number of additional information used in each model, memory space of W*H*K*(C+N) is generally required, wherein N is configured of three values, such as standard deviation, dispersion, and model weights. However, such a model may be constituted in other shapes according to each application.

The post-processing unit 116 serves to remove noise and to further highlight the moving object in the result of the data processing unit 114. Considerable noise are generally generated in an image binarization process that is performed after performing an operation using a background separation method and it largely impacts extraction accuracy of the object to be tracked. Although an operation such as Markov Random Field Model has been used in the related art to achieve such a target, it requires considerable computational quantity so that a simple Morphological operation is used.

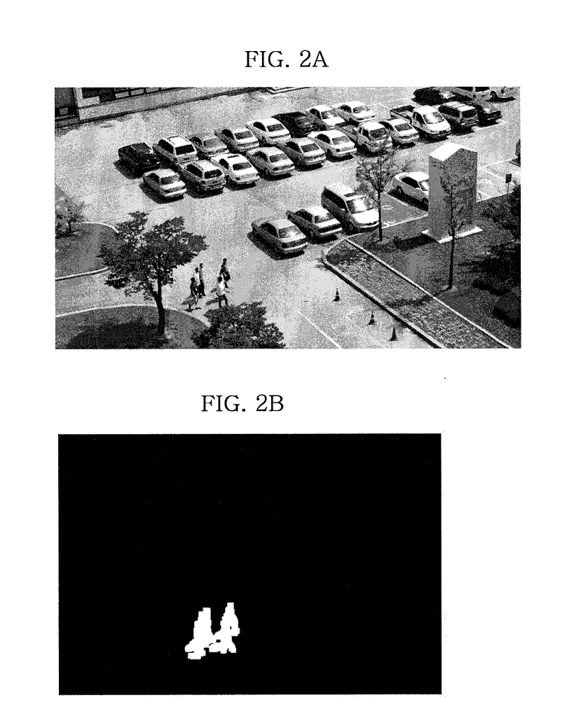

Meanwhile, the method for extracting the object to be tracked (dynamic area) in the dynamic area extracting unit 110 is not always limited to the method as described above but various methods may be used. The extracted result of the object to be tracked extracted through the dynamic area extracting part 110 is represented by FIG. 2B, wherein it is represented by being divided into a dynamic area and a non-dynamic area. FIG. 2A represents an original image frame collected through the still image collecting apparatus 10.

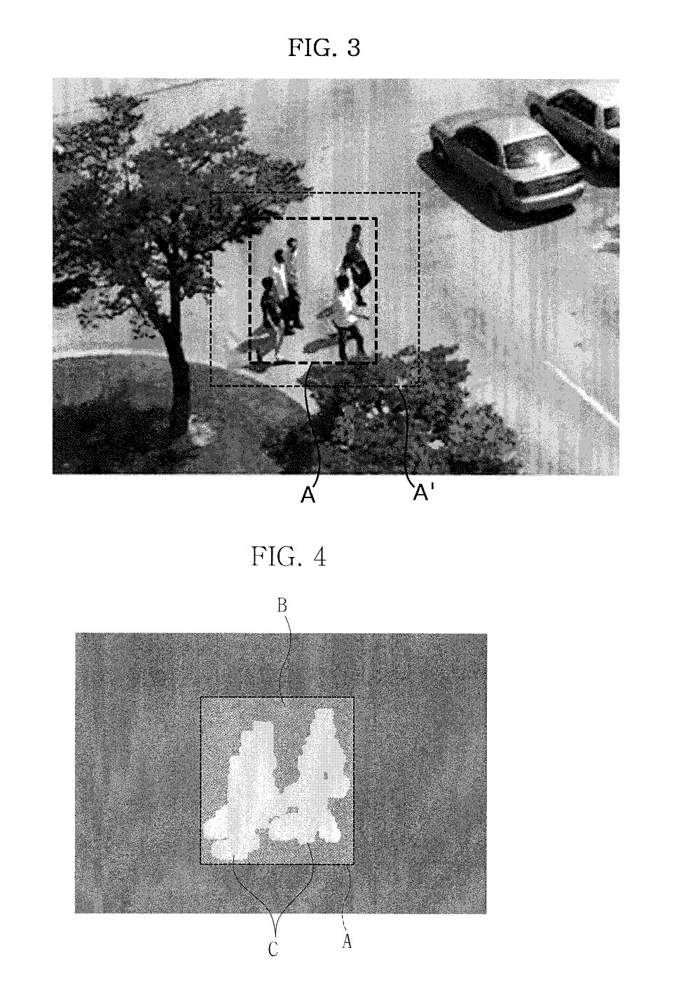

Before the present invention, statistical modeling represented in equation 1 has progressed by considering the area extracted as the moving object (object to be tracked) to be a rectangular area (A in FIG. 3), the inside of the rectangular area to be an object to be tracked, and the outside thereof to be a background.

$$P ( O \vert \overline{C} ) = \frac{P ( \overline{C} \vert O ) P ( O )}{P ( \overline{C} )} \qquad [ Equation 1 ]$$

Herein, P(O| C̅)means probability that color distribution represents an object to be tracked, P( C̅|O) means color distribution obtained from the object to be tracked, P(O) means a prior probability of the object to be tracked, and P( C̅) means a prior probability of color.

In other words, the object to be tracked is considered to be a conditional probability (P(O| C̅)) and the posterior probability thereof is inferred using Baysian's Formula. At this time, the color that becomes the element of the distribution may use any color space such as HSV, YUV, Normalized RGB, etc. as described above and furthermore, the number of used channels is also flexible.

For example, only the H channel of the HSV color space may be used or two channels of the normalized RGB color space may be used. The important thing is that the color space of each pixel has the distribution related to the probability and any channel of any color space may be used if this condition is satisfied, wherein this may be changed according to each application.

However, by obtaining the probability of only the object to be tracked as shown in equation 1, it may cause an unstable tracked result such as general CAMShift or MeanShift so that the more accurate tracking is performed by being modeled with the background in the present invention. Herein, the background does not mean a background image corresponding to the input image frame but means a predetermined area of background image including the object to be tracked. In FIG. 3, A′ may correspond to the background.

As can be confirmed in FIG. 4, when the area of the object to be tracked is extracted as a rectangular area (A in FIG. 4) from the input image frame, portions excluding the actually moving object (C in FIG. 4) becomes the area of the object to be tracked (B in FIG. 4). Therefore, the area to be modeled with the object to be tracked is not simply extracted as the rectangular area (A in FIG. 4) but only the area showing the portions where actual object moves as shown in FIG. 4C is extracted as the object to be tracked.

The object modeling unit 130 models the object to be tracked extracted through the dynamic area extracting unit 110 to calculate the color distribution of the object to be tracked. In the present invention, ‘modeling’ means a process of obtaining a color distribution of a moving object (object to be tracked).

When tracking an object, the image collecting apparatus 10 should be moved together with the object to be tracked so that the background is also continuously changed. Therefore, the color distribution of the background is continuously performed in the object tracking unit 150 rather than the object modeling unit 130. This will be described in more detail through the object tracking unit 150 to be described later.

The object modeling unit 130 may give different weights for each channel in order to obtain the conditional probability of the object to be tracked and the background, while performing modeling. For example, the number of bins to be used in a histogram may be set to be different from each other for each channel. If the HSV color space is used to intend to implement an object tracking apparatus sensitive to color and less sensitive to brightness, the number of bins for H may be set to eight and the number of bins for V may be set to three.

The object modeling unit 130 performs modeling on a plurality of objects to be tracked extracted from a plurality of image frames (n frame) through the dynamic area extracting unit 110 to calculate the color distribution of the object to be tracked. At this time, the proper selection of n and the method for accumulating the color probability represented by the object to be tracked may be different for each application. This may be performed until the modeling probability of the object to be tracked reaches convergence according to utilization methods or, most simply determining a specific n, it may calculate the color distribution of the object to be tracked using an average value for each modeling probability.

The object tracking unit 150, which tracks the object to be tracked using the color distribution of the object to be tracked calculated through the object modeling unit 130, receives a next image frame collected through the image collecting apparatus 10, after the color distribution of the object to be tracked is calculated in the object modeling unit 130, to calculate the color distribution of the input image frame. And, the object tracking unit 150 calculates the posterior probability that each pixel belongs to the object to be tracked based on the color distribution of the calculated next image frame and the color distribution of the object to be tracked, thereby tracking the object to be tracked. In other words, the object tracking unit 150 has a continuous process of determining the size of the object to be tracked and the center thereof using momentum for the probability for each pixel in the next image frame.

The object tracking unit 150 includes an image modeling unit 152, a tracking unit 154, and a driving control unit 156.

The image modeling unit 152 receives the next image frame collected through the image collecting apparatus 10 to calculate the color distribution of the image frame.

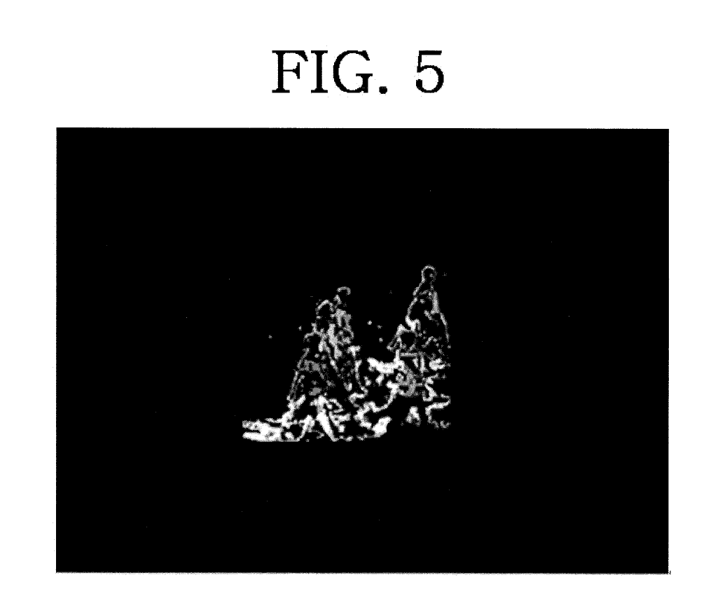

The tracking unit 154 calculates the posterior probability that each pixel belongs to the object to be tracked in the next image frame using the color distribution of the image frame calculated through the image modeling unit 152 and the color distribution of the object to be tracked calculated through the object modeling unit 130, thereby tracking the object to be tracked. The object to be tracked should be moved together with the image collecting apparatus 10 so that the background of the object to be tracked is continuously changed. Therefore, as described above, the posterior probability belonging to the object that pixels should track is obtained using the probability belonging to the ground that each pixel has for each image frame and the probability belonging to the object to be tracked. FIG. 5 shows a result that the posterior probability for the object to be tracked is obtained in the tracking unit 154. As shown in FIG. 5, modeling is performed except for the area actually not moving between persons so that pixels with high probability remain only in the area of the object to be tracked. This method may show good performance in the application of tracking that the size of the object is changed or the shape of the object, such as a person or a hand, itself is changed.

Meanwhile, when the object to be tracked is hidden by other objects or disappears from the input image frame, the tracking unit 154 provides a method to sense it and to continuously track the object. When the above function is not provided in the tracking unit 154, it is very likely to perform a wrong track according to very small probability that the background accidentally has, even though an actual object to be tracked does not exist in the input image frame. Therefore, the tracking unit 154 determines whether the object to be track exists in the input image frame and, when the object to be track does not exist in the input image frame, gradually zooms out the ground area as time elapses, to continuously perform an examination on whether the object to be tracked exists in the background of the image frame. At this time, if it is determined that the object appears again, the tracking of the object starts in the same manner as described above. If the background area becomes larger than a predetermined size (it is the same as when a predetermined time elapses), it is determined to fail in tracking the object to complete the tracking of the object and to perform again an extraction for objects moving in the input image frame.

Any method using probability may be applied to the method of determining whether the object to be tracked exists in the input image frame in the tracking unit 154. For example, if the tracking unit 154 calculates the probability that is the object to be tracked using the color distribution of the object to be tracked and the color distribution of the next input image and when the probability that is the calculated object to be tracked does not satisfy the predetermined threshold value, it may be determined that the object does not exist in the input image frame. When being determined as that the object does not exist in the input image frame through this method, the tracking unit 154 magnifies the background area of the image frame collected through the image collecting apparatus 10 by zoom-out controlling the image collecting apparatus 10 at a predetermined ratio.

When the object to be tracked disappears from the input image frame, it may be divided into cases where the object to be tracked is temporarily hidden by other objects and the object completely disappears such that it is impossible to perform a continuous tracking. In either of the cases, it is not clear which position of the input image frame the object to be tracked will appear again. However, there is a probability that the object will appear again around the position where it disappears so that it is effective to track the object, while magnifying the background area at a predetermined ratio as time elapses as described above. To this end, it is preferable that the image collecting apparatus 10 applied to the present invention basically supports the PTZ function.

The driving control unit 156 controls the operation of the image collecting apparatus 10 according to the control signals from the tracking unit 154.

The driving control unit 156 controls the vision direction of the image collecting apparatus so that the center of the object to be tracked determined through the tracking unit 154 is positioned at the center of the next image frame collected by the image collecting apparatus 10. And, the driving control unit 156 controls the PTZ function of the image collecting apparatus 10 according to the control signals input from the tracking unit 154.

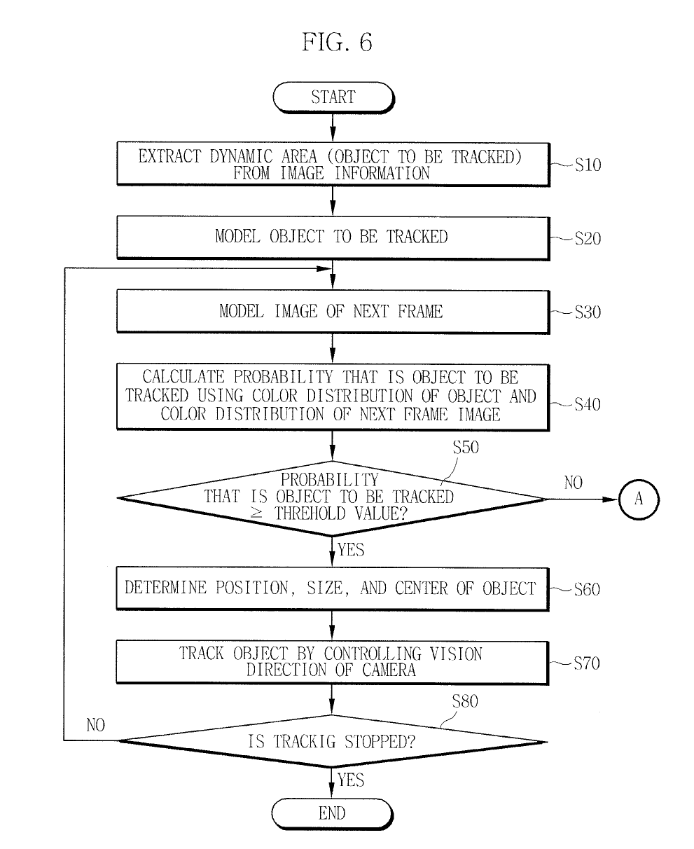

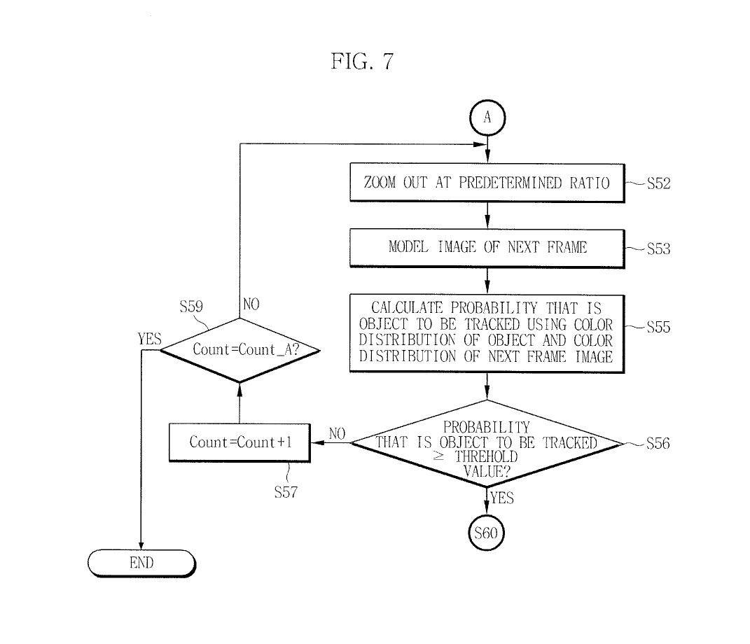

FIGS. 6 and 7 are flow charts explaining a method for effectively tracking an object using a moving camera according to the embodiment of the present invention.

Referring to FIGS. 6 and 7, first, the dynamic area extracting unit extracts the moving object to be tracked (hereinafter, referred to as ‘object to be tracked’) from the image frame (image information) input through the image collecting apparatus (for example, a camera) (S10). The extracted result of the object to be tracked extracted through the dynamic area extracting unit is represented by FIG. 2B, wherein it is represented by being divided into a dynamic area and a non-dynamic area.

Next, the dynamic area extracting unit transfers the object to be tracked extracted from the input image frame to the object modeling unit, and the object modeling unit models the input object to be tracked to calculate the color distribution of the object to be tracked (S20). When tracking the object, the image collecting apparatus should be moved together with the object to be tracked so that the background is also continuously changed. Therefore, the color distribution of the background is continuously performed in the object tracking unit rather than the object modeling unit. The object modeling unit may give different weights to each channel for obtaining the conditional probability of the object to be tracked and the background, while performing the modeling. Also, the object modeling unit may receive the plurality of objects to be tracked extracted from the plurality of image frames (n frames) through the dynamic area extracting unit to perform modeling thereon, thereby calculating the color distribution of the objects to be tracked. At this time, the proper selection of n and the method for accumulating the color probability represented by the object to be tracked may be different for each application.

Next, the object tracking unit tracks the object to be tracked using the color distribution of the object to be tracked calculated through the object modeling unit. More specifically, after calculating the color distribution of the object to be tracked, the object modeling unit receives the next image frame collected through the image collecting apparatus to perform modeling, thereby calculating the color distribution of the input image frame (S30).

And, the object tracking unit calculates the posterior probability that each pixel belongs to the object to be tracked in the next image frame based the color distribution of the calculated next image frame and the color distribution of the object to be tracked, thereby tracking the object to be tracked. In other words, the object tracking unit has a continuous process of determining the size of the object to be tracked and the center thereof using momentum for the probability for each pixel in the next image frame (S60). At this time, the object tracking unit calculates the probability that is the object to be tracked using the color distribution of the object to be tracked and the color distribution of the next image frame (S40), and determines whether the probability that is the calculated object to be tracked satisfy the predetermined threshold value (S50).

As a result of the determination in step S50, when the probability that is the object to be tracked does not satisfy the predetermined value, the image collecting apparatus is zoom-out controlled at a predetermined ratio (S52), and determines whether the object to be tracked exists in the background in the next input image frame. At this time, the method to determine whether the object to be tracked exists in the image frame may be achieved by the same method as shown in steps S40 to S50.

More specifically, the modeling is performed on the image frame input through the image collecting apparatus after step S52 to calculate the color distribution (S53), and the probability that the object to be tracked exists in the image frame (that is, the probability that is the object to be tracked) is calculated using the color distribution calculated in step S53 and the color distribution of the object to be tracked (S55).

And, it is determined whether the probability that is the object to be tracked calculated through step S55 satisfies the predetermined threshold value (S56).

As a result of the determination in step S56, when the probability that is the object to be tracked satisfies the predetermined threshold value, the position, size, and center of the object to be tracked are determined by being moved to step S60.

As a result of the determination in step S56, when the probability that is the object to be tracked does not satisfy the predetermined threshold value, the tracking process as above is repeated (S52 to S56), while magnifying the background area in the image frame collected through the image collecting apparatus by zoom-out controlling the image collecting apparatus at a predetermined ratio as time elapses. At this time, if a predetermined time elapses (S59, that is, if the background area becomes larger than a predetermined size), the tracking unit determines that the tracking of the object is failed to complete the tracking of the object and performs again an extraction on objects moving in the input image frame.

Meanwhile, as a result of the determination in step S50, when the probability that is the object to be tracked does not satisfy the threshold value, there is provided a continuous process of determining the size of the object to be tracked and the center thereof using momentum for the probability for each pixel in the next image frame (S60).

If the size, position, and center of the object to be tracked are determined through step S60, the tracking unit tracks the object by controlling the vision direction of the image collecting apparatus so that the center of the object to be tracked is positioned at the center of the next image frame collected through the image collecting apparatus through the driving control unit (S70). The tracking unit repeats aforementioned steps S30 to S70 and tracks the object before tracking stop signals are input, and completes the process if the tracking stop signals are input.

With the present invention, compared to the method for tracking the object that is operated using the still camera in the related art, the tough object tracking can be performed in the environment where the object is moved together with the background. This is the reason that the modeling is performed on only the object to be tracked in the related art, but modeling is performed for each frame by considering it together with the neighboring environment thereof in the present invention.

Therefore, the adaptive object tracking can be performed even in the environment where the neighboring background continuously changes as the camera is moved together with the object.

Moreover, the tracking based on the probability using the color distribution of the object to be tracked rather than the template matching method is performed, making it possible to continuously track the object to be tracked, even though the size thereof is changed.

Some of the steps of the present invention can be implemented as codes that a computer can read in recording medium that can be read by the computer. The recording medium that can be read by the computer includes all sorts of recording apparatuses in which data that can be read by a computer system are stored. As the recording medium that can be read by the computer, for example, there may be ROM, RAM, CD-ROM, CD-RW, magnetic tape, floppy disk, HDD, optical disk, magnetic-optical storage apparatus, etc., and further may include a carrier wave form (for example, transmission through Internet). Also, the recording medium that can be read by the computer is dispersed into a computer system connected in a network so that it can be stored as a code that can be read by the computer in a dispersion scheme and be executed.

As described above, the preferred embodiments have been described and illustrated in the drawings and the description. Herein, specific terms have been used, but are just used for the purpose of describing the present invention and are not used for qualifying the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. An apparatus for tracking an object, comprising:
a dynamic area extracting unit that extracts an object to be tracked from an image frame collected through an image collecting apparatus;
an object modeling unit that models the object to be tracked extracted through the dynamic area extracting unit to calculate the color distribution of the object to be tracked; and
an object tracking unit that calculates the color distribution of a next image frame collected through the image collecting apparatus, after calculating the color distribution of the object to be tracked, and calculates a posterior probability that each pixel belongs to the object to be tracked in the next image frame based on the calculated color distribution of the next image frame and the color distribution of the object to be tracked to track the object to be tracked.

2. The apparatus for tracking the object according to claim 1, wherein the dynamic area extracting unit extracts the object to be tracked for the image frame collected through the still image collecting apparatus.

3. The apparatus for tracking the object according to claim 1, wherein the dynamic area extracting unit includes:
a color space converting unit that converts the color space of the input image frame into a target color space to which weights for each image channel are given; and
a data processing unit that processes image data of which color space is converted through the color space converting unit to separate the object to be tracked from background.

4. The apparatus for tracking the object according to claim 3, further comprising:
a post-processing unit that removes noise from the result image of the data processing unit to highlight the object to be tracked.

5. The apparatus for tracking the object according to claim 1, wherein the object tracking unit includes a tracking unit that determines the size and center of the object to be tracked using the calculated posterior probabilities.

6. The apparatus for tracking the object according to claim 5, wherein the object tracking unit includes a driving control unit that controls the vision direction of the image collecting apparatus so that the center of the object to be tracked determined through the tracking unit is positioned at the center of the next image frame collected through the image collecting apparatus.

7. The apparatus for tracking the object according to claim 1, wherein the object modeling unit uses a histogram to model the extracted object to be tracked and uses the different number of bins to be used in the histogram for each channel.

8. The apparatus for tracking the object according to claim 1, wherein the dynamic area extracting unit extracts the object to be tracked from a plurality of image frames collected through the still image collecting apparatus, and the object modeling unit performs modeling on the objects to be tracked extracted through the plurality of image frames to calculate the color distribution of the object to be tracked.

9. The apparatus for tracking the object according to claim 8, wherein the object modeling unit models the object to be tracked until the modeling probability of the object to be tracked reaches convergence.

10. The apparatus for tracking the object according to claim 8, wherein the object modeling unit performs modeling on the objects to be tracked extracted through the plurality of image frames and then calculates the color distribution of the object to be tracked using an average value of each modeling probability.

11. A method for tracking an object, comprising:
extracting an object to be tracked from an image frame collected through an image collecting apparatus;
calculating the color distribution of the object to be tracked by modeling the extracted object to be tracked;
calculating the color distribution of the object to be tracked and then calculating the color distribution of a next image frame collected through the image collecting apparatus; and
calculating a posterior probability that each pixel belongs to the object to be tracked in the next image frame based on the calculated color distribution of the next image frame and the color distribution of the object to be tracked to track the object to be tracked.

12. The method for tracking the object as claimed in claim 11, wherein the extracting the object to be tracked from the image frame collected through the image collecting apparatus comprises extracting the object to be tracked for the image frame collected through the still image collecting apparatus.

13. The method for tracking the object as claimed in claim 11, wherein the calculating the posterior probability that each pixel belongs to the object to be tracked in the next image frame based on the calculated color distribution of the next image frame and the color distribution of the object to be tracked to track the object to be tracked includes determining the size and center of the object to be tracked using the calculated posterior probability.

14. The method for tracking the object as claimed in claim 11, wherein the calculating the posterior probability that each pixel belongs to the object to be tracked in the next image frame based on the calculated color distribution of the next image frame and the color distribution of the object to be tracked to track the object to be tracked includes controlling the vision direction of the image collecting apparatus so that the center of the object to be tracked is positioned at the center of the next image frame collected through the image collecting apparatus.

15. The method for tracking the object as claimed in claim 11, wherein the calculating the color distribution of the object to be tracked by modeling the extracted object to be tracked comprises using a histogram to model the extracted object to be tracked and using the different number of bins to be used in the histogram for each channel.

16. The method for tracking the object as claimed in claim 11, wherein the calculating the color distribution of the object to be tracked by modeling the extracted object to be tracked comprises performing modeling on the objects to be tracked extracted through the plurality of image frames to calculate the color distribution of the object to be tracked.

17. The method for tracking the object as claimed in claim 16, wherein the performing modeling on the objects to be tracked extracted through the plurality of image frames comprises modeling the object to be tracked until the modeling probability of the extracted object to be tracked reaches convergence.

18. The method for tracking the object as claimed in claim 16, wherein the performing modeling on the objects to be tracked extracted through the plurality of image frames comprises performing modeling on the objects to be tracked extracted through the plurality of image frames and then calculating the color distribution of the object to be tracked using an average value of each modeling probability.

19. The method for tracking the object as claimed in claim 11, wherein the calculating the posterior probability that each pixel belongs to the object to be tracked in the next image frame based on the calculated color distribution of the next image frame and the color distribution of the object to be tracked to track the object to be tracked includes:
determining whether the object to be tracked exist in the next image frame using the calculated posterior probabilities;
when the object to be tracked does not exist in the next image frame, zoom-out controlling the image collecting apparatus at a predetermined ratio; and
determining whether the object to be tracked exist in the next image frame using the image zoom out collecting apparatus at a predetermined ratio.
